(19) United States
(12) Patent Application Publication
(10) Pub. No.: US 2008/0074685 A1
(43) Pub. Date: Mar. 27, 2008

(54) Image processing apparatus, image processing method, and computer readable recording medium stored with image processing program

(75) Inventor: Shigeru Sakamoto, Sagamihara (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Tokyo (JP)

(21) Appl. No.: 11/806,038

(22) Filed: May 29, 2007

(30) Foreign Application Priority Data
Sep. 25, 2006 (JP) 2006-258766

(51) Int. Cl. G06F 15/00

(52) U.S. Cl. 358/1.9

(57) ABSTRACT

The printer controller divides the image data within each page, compare the divided areas of various pages to identify separately the common areas that can be used in a plurality of pages from the unique areas that do not belong to said common areas, applies RIP as an image process for printing to the unique areas and the common areas for one of the plurality of pages containing the common areas, synthesizes the common areas and the unique areas to which RIP was applied, and outputs the synthesized image data to the printer.

### CROSS-REFERENCE TO RELATED APPLICATION

This application is based on Japanese Patent Application No. 2006-258766, filed on Sep. 25, 2006, the contents of which are incorporated herein by reference.

### BACKGROUND

1. Technical Field

The present invention relates to an image processing apparatus, an image processing method, and a computer readable recording medium stored with an image processing program.

The present invention relates to an image processing apparatus, an image processing method, and a computer readable recording medium stored with an image processing program, in particular, for applying an image process for printing to image data having a common area to be used in common among a plurality of pages.

2. Description of the Related Art

It takes an enormous amount of time to reproduce image data (hereinafter called also “raster image”) in a bitmap-format used in printing in case of mass-printing such things as direct mail, labels and business forms where pictures and photographs are used abundantly.

As one solution to this, a system called “variable data printing” has been proposed. Variable data printing method means a printing method in which the output contents of each page can be partially replaced depending on the needs. In the variable data printing system, the printing data contains reusable objects that can be used repeatedly and unreusable objects as minimum constituents. Whether an object is a reusable object or a unreusable object is also clearly differentiated in the layout information of the printing data. The layout information also describes how object groups are laid out within a page. A printing apparatus that supports a variable data printing language caches on a memory unit or a hard disk a raster image formed by applying RIP (Raster Image Process) to a reusable object in the printing data and reuses this cached raster image to reduce the time needed for RIP in order to improve its performance.

A printing control apparatus has also been proposed in which, in order to output page images at an approximately constant speed, an image of each page, i.e., a raster image, is generated first by synthesizing a variable image and a fixed image, and each page image is then stored by dividing it into a variable strip group and a fixed strip group, which are resynthesized at the time of printing later. See unexamined patent publication No. 2000-137587. The printing control apparatus generates each page image by generating a fixed image common to a plurality of pages and a variable image that varies with each page by analyzing the printing data received, and then synthesizing the variable image and the fixed image. Later the printing control apparatus divides each page image into a plurality of strips, stores them into a memory in separate groups consisting of a variable strip group containing variable images and a fixed strip group containing other images, forms at the time of printing by resynthesizing the data of the variable strip group and the fixed strip group, and outputs the particular page image to the printing apparatus.

However, the printing data in such a technology of the conventional art always has to be a file of a style that clearly separates a common area that is used commonly on a plurality of pages and an unique area that does not belong to said common area. Therefore, it presents a problem that it requires a dedicated application program and a printing system that can produce and understand such printing data. It also presents to a user who prepares printing data and a business operator who prints the product based on the printing data a problem that their works become more complicated as it forces them business flows that are different from the flows they employ in dealing with printing data, for example, described in general purpose PDL (Page Description Language).

### SUMMARY

To solve at least one of the abovementioned problems, an image processing apparatus reflecting one aspect of the present invention comprises an image analyzing unit for dividing image data into a plurality of areas of equal sizes within a page, comparing the equally divided areas between pages, and identifying a common area that can be used in a plurality of pages and a unique area that does not belong to said common area; an image processing unit for applying an image process for printing to said unique area and said common area for one of the plurality of pages containing said common area; an image synthesizing unit for synthesizing said common area and said unique area to which said image process has been applied; and an output unit for outputting the synthesized image data to a printing unit.

To solve at least one of the abovementioned problems, an image processing apparatus reflecting one aspect of the present invention comprises an image analyzing unit for dividing image data into a plurality of areas of equal sizes within a page, comparing the equally divided areas between areas, and identifying a common area that can be used in a plurality of areas and unique area that does not belong to said common area; an image processing unit for applying an image process for printing to said unique area and said common area as one area common to the plurality of areas and; an image synthesizing unit for synthesizing said common area and said unique area to which said image process has been applied; and an output unit for outputting the synthesized image data to a printing unit.

The objects, features, and characteristics of this invention other than those set forth above will become apparent from the description given herein below with reference to preferred embodiments illustrated in the accompanying drawings.

### BRIEF DESCRIPTION OF THE DRAWINGS

FIG. 1 is an overall constitutional diagram of the printing system according to a first embodiment of the invention.

FIG. 2 is a block diagram showing the general constitution of a client terminal.

FIG. 3 is a block diagram showing the general constitution of a printer controller.

FIG. 4 is a block diagram showing the general constitution of a printer.

FIG. 5 is a flowchart showing the process sequence on the printer controller.

FIG. 6 is a flowchart showing the procedure of a raster image analyzing process.

FIG. 7 is a diagram showing printing data.

FIG. 8 is a drawing to show an example RGB raster image generated with a low resolution.

FIG. 9 is a drawing to show an example RGB raster image of the last page with a low resolution.

FIG. 10 is a drawing to show an example raster image divided into M×N areas.

FIG. 11 shows an example table of hash values of various areas in the RGB raster image of a single page.

FIG. 12 shows an example table of hash values of various areas in the RGB raster images of all pages.

FIG. 13 is a table showing the list of the result of comparing the areas and matching ratio of each page.

FIG. 14 is a table showing the list of matching ratio of each area.

FIG. 15 is a table showing the result of discrimination between the common areas and the unique areas.

FIG. 16 shows an example of page information.

FIG. 17 is a flowchart showing the procedure of a raster image generating process.

FIG. 18 is a flow chart, continuing from FIG. 17, showing the raster image generating procedure.

FIG. 19 is a table showing new printing data.

FIG. 20 is a flowchart showing the procedure of the image synthesizing and printing process.

FIG. 21 is a flow chart, continuing from FIG. 20, showing the image synthesizing and printing procedure.

FIG. 22 is a drawing to show an example RGB raster image generated with a low resolution in a second embodiment.

FIG. 23 shows an example table of hash values of various areas in the RGB raster images of all pages in the second embodiment.

FIG. 24 is a table showing the list of the result of comparing the areas and matching ratio by page in the second embodiment.

FIG. 25 is a table for describing a process of grouping pages.

FIG. 26 is a table for describing a process of grouping pages.

FIG. 27 is a table showing the final status of grouping pages.

FIG. 28 is a drawing to show an example RGB raster image generated with a low resolution in a third embodiment.

FIG. 29 is a table showing the list of the result of comparing the areas and matching ratio by page in the third embodiment.

FIG. 30 is a table showing the list of hash values of the reusable area.

FIG. 31 is a hash table.

### DETAILED DESCRIPTION

The preferred embodiments of the invention will be described in detail below with reference to the accompanying drawings.

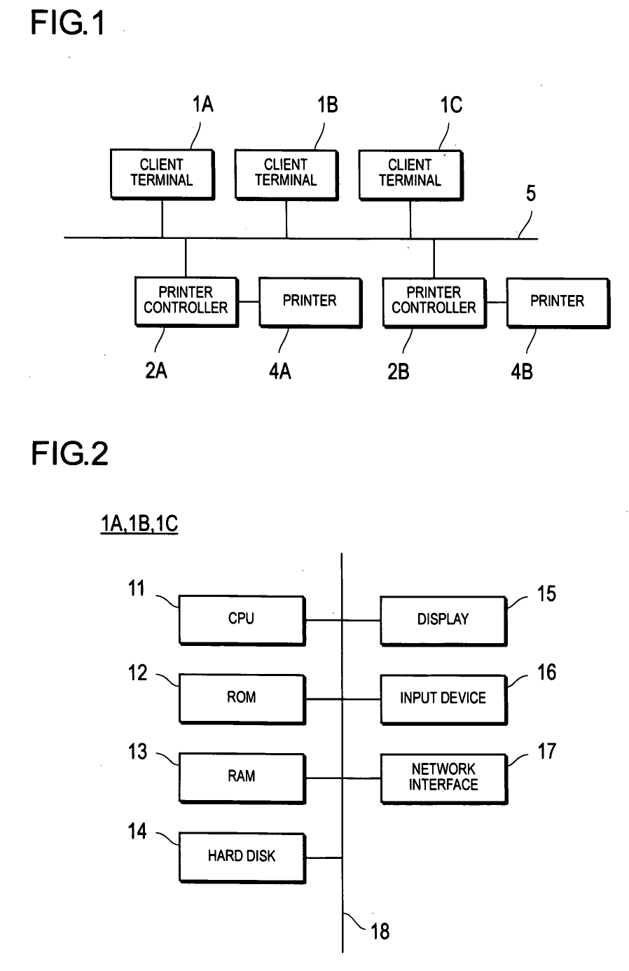

FIG. 1 is an overall constitutional diagram of the printing system according to a first embodiment of the invention.

The printing system is equipped with client terminals 1A, 1B, and 1C; printer controllers 2A and 2B; and printers 4A and 4B.

The client terminals 1A, 1B, and 1C and the printer controllers 2A and 2B are interconnected with each other via a network 5 to be communicable with each other. The network 5 can be a LAN connecting computers and network equipment according to standards such as Ethernet®, Token Ring, and FDDI, or a WAN that consists of several LANs connected by a dedicated line. The printer controllers 2A and 2B and the printers 4A and 4B are connected respectively via dedicated interface buses such as IEEE 1394 serial buses. However, a printer controller and a printer can be connected via the network 5 as well. The types and the number of equipment to be connected to the network 5 are not limited to those shown in FIG. 1.

Next, constitution of each device mentioned above will be described below, but the description of a function common to multiple devices will be made only once when it first appears and will not be repeated afterwards in order to avoid duplicate descriptions.

FIG. 2 is a block diagram showing the general constitution of the client terminals 1A, 1B, and 1C. The client terminals 1A, 1B, and 1C are typically PCs (personal computers). Since the client terminals 1A, 1B, and 1C have identical constitutions with each other, the client terminal 1A shall be used to represent all of them in the following description.

The client terminal 1A contains a CPU 11, a ROM 12, a RAM 13, a hard disk 14, a display 15, an input device 16 and a network interface 17, all of which are interconnected by a bus 18 for exchanging signals.

The CPU 11 controls various parts indicated above and executes various arithmetic processes according to a program. The ROM 12 stores various programs and data. The RAM 13 stores programs and data temporarily as a working area. The hard disk 14 stores various programs including an operating system and data.

The hard disk 14 has an application program for generating document files and a printer driver for converting document files into printing data (PDL data) described in a PDL understood by the printer controllers installed. The PDL can be such as PDF (Portable Document Format) and PS (PostScript®).

The display 15 is typically a LCD or a CRT and displays various kinds of information. The input device 16 includes a pointing device such as a mouse, a keyboard, and others, and is used for executing various kinds of inputs. The network interface 17 is typically a LAN card and is used for communicating with external equipment via the network 5.

The client terminal 1A prepares printing data as a printing job and transmits it to the printer controller. The client terminal 1A is also capable of monitoring the processing conditions at the printer controllers 2A and 2B and displaying page raster images prepared in the printer controllers 2A and 2B.

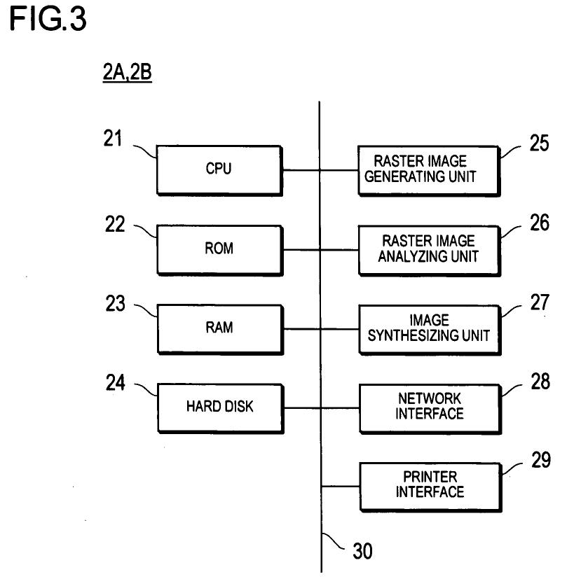

FIG. 3 is a block diagram showing the general constitution of the printer controllers 2A and 2B. Since the printer controllers 2A and 2B have identical constitutions, the printer controller 2A shall be used to represent both in the following description.

The printer controller 2A contains a CPU 21, a ROM 22, a RAM 23, a hard disk 24, a raster image generating unit 25, a raster image analyzing unit 26, an image synthesizing unit 27, a network interface 28, and a printer interface 29, all of which are interconnected via a bus 30 for exchanging signals.

The raster image generating unit 25 applies RIP to the printing data received as a printing job from the client terminal 1A, and generates a raster image, i.e., image data in the bitmap-format.

The raster images thus generated include an RGB image of a low resolution to be used in the raster image analyzing unit 26 and a CMYK raster image of a high resolution to be used in printing. The RGB raster images of the low resolution are stored on the hard disk 24, an external storage unit. There are two kinds of CMYK raster images of the high resolution, form images that are used commonly on a plurality of pages and unique images that are used only once. The form images and the unique images are stored on the RAM 23, a main memory.

The raster image analyzing unit 26 analyzes the RGB raster image of the low resolution generated by the raster image generating unit 25. The raster image analyzing unit 26 outputs the analysis result as page information. The page information is stored in the RAM 23.

The image synthesizing unit 27 produces a page raster image which is a raster image for one page by synthesizing the form image and the unique image based on the page information.

The printer interface 29 is an interface for communicating with the printer 4A.

Although the raster image generating unit 25, the raster image analyzing unit 26, and the image synthesizing unit 27 are built as hardware in the present embodiment, it can also be constituted in such a way that a memory unit such as the ROM 22 stores programs that correspond to those units and the CPU 21 executes those programs in order to implement the functions of those units.

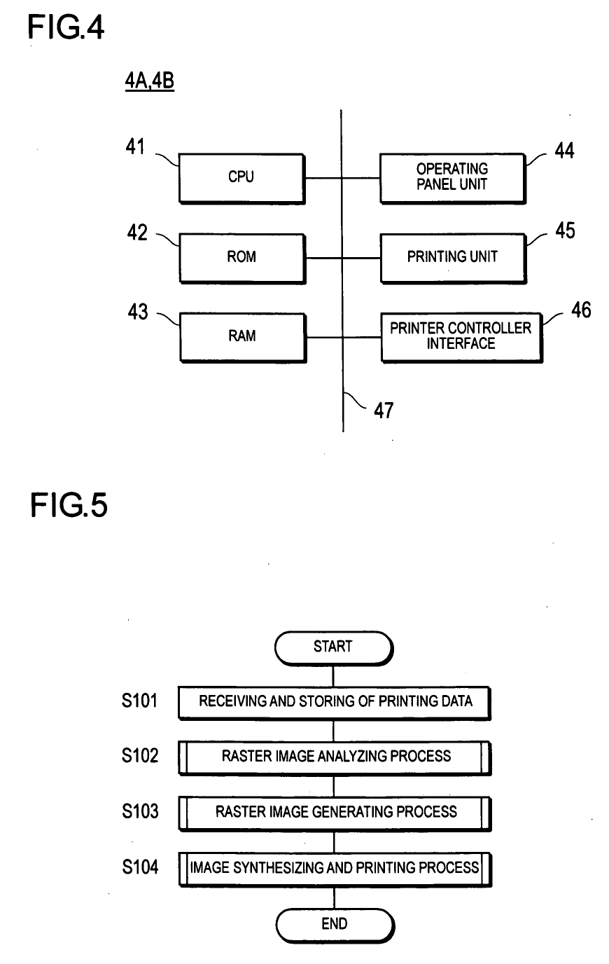

FIG. 4 is a block diagram showing the general constitution of a printer 4A. Since the printers 4A and 4B have identical constitutions, the printer 4A shall be used to represent both in the following description.

The printer 4A has a CPU 41, a ROM 42, a RAM 43, an operating panel unit 44, a printing unit 45, and a printer controller interface 46, all of which are interconnected with each other via a bus 47 for exchanging signals.

The operating panel unit 44 is used for various information displays and for entering various instructions. The printing unit 45 prints image data on recording media such as paper using a known imaging process such as the electronic photographing process including such processes as electrical charging, exposure, developing, transferring and fixing. The printer controller interface 46 is an interface for communicating with the printer controller 2A.

The client terminals 1A, 1B, and 1C; the printer controllers 2A and 2B; and the printers 4A and 4B can contain components other than those components mentioned above, or do not have to contain all of the components mentioned above.

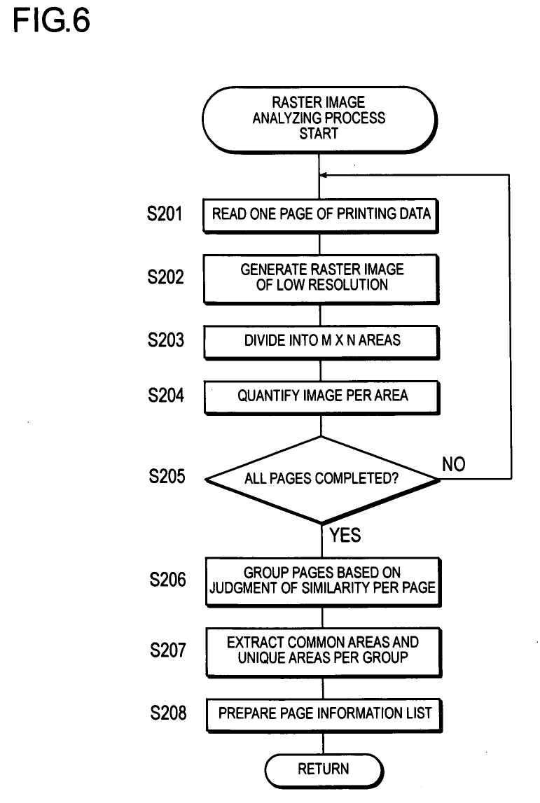

Next, the job process in the printer controller 2A will be described below referring to FIG. 5. The algorithm shown described by a flowchart of FIG. 5 is stored as a program in a storage unit such as the hard disk 24 of the printer controller 2A and is executed by the CPU 21 (it is the same in the case of the algorithm described by flowcharts of FIGS. 6, 17, 18, 20 and 21).

In advance, the user prepares printing data for a printing job using the printer driver installed in the client terminal 1A. The prepared printing data are transmitted to the printer controller 2A via the network 5.

First, the printer controller 2A receives the printing data from the client terminal 1A and stores the received printing data on the hard disk 24 (S101).

Then, the raster image analyzing process will be performed (S102). In the raster image analyzing process, the image data contained in the printing data are divided into equal parts within each page and the equally divided parts are compared among various pages in order to identify the common areas that are commonly used in a plurality of pages from the unique areas that do not belong to the common areas. The image data used here is the bitmap-formatted image data converted to have a resolution lower than that of the bitmap-formatted image data used for printing. The details of the raster image analyzing process will be described later.

Next, the raster image generating process will be performed (S103). In the raster image generating process, the unique areas and the common areas for one page among a plurality of pages having the common areas are applied with RIP, which is an image process for converting them into bitmap-formatted image data of the resolution used in printing, in order to generate the form images and the unique images respectively. The details of the raster image generating process will be described later.

Then, the image synthesizing and printing process is executed (S104). In the image synthesizing and printing process, the common areas and the unique areas that are applied with RIP are synthesized to generate a page raster image, i.e., a synthesized image data, which is then outputted to the printer 4A. Then, the printer 4A prints the received page raster image on a recording medium such as paper. The details of the image synthesizing and printing process will be described later.

Next, let us describe the raster image analyzing process with reference to FIG. 6.

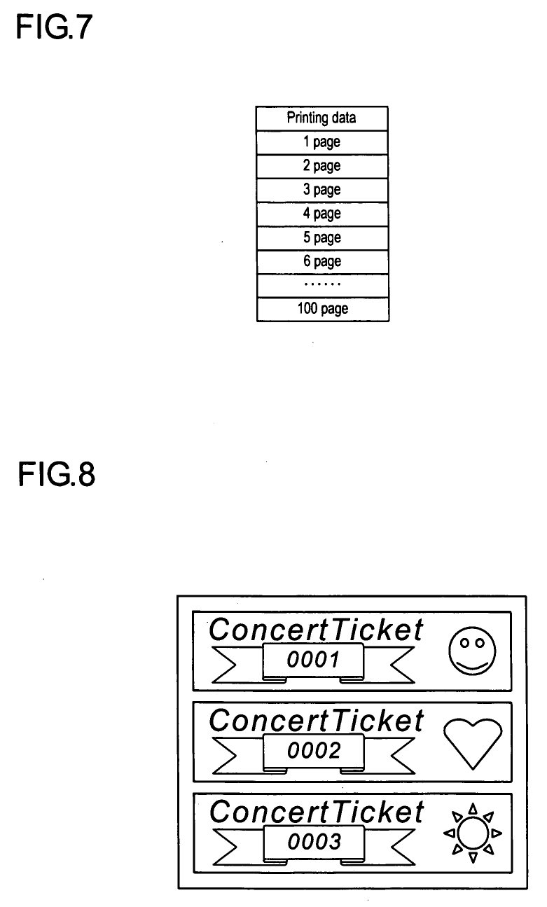

First, the information for one page is read from the printing data stored in the hard disk 24 and entered into the RAM 23 (S201). FIG. 7 is a diagram showing printing data.

Next, the information thus entered is analyzed to generate a RGB raster image of a low resolution (S202). FIG. 8 is a drawing to show an example RGB raster image generated with a low resolution. The RGB raster image of a low resolution is generated here in order to minimized the generating time and the analyzing time.

The generated RGB raster image is equally divided into M (rows)×N (columns) as shown in FIG. 10 (S203). In FIG. 10, the RGB raster image is divided into six rows and four columns. It is preferable to divide the RGB raster image equally in a lattice pattern within one page from the standpoint of an efficient process. This provides a particularly efficient process in case of data that the majority of images are common among a plurality of pages and only a small portion of images are different. The dividing numbers M×N are arbitrary and preset.

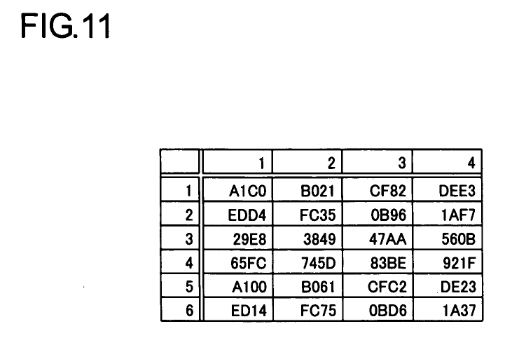

Later, each of these equally divided areas is quantified (S204). In other words, the hash value for each area is calculated using the hash function by entering the pixel values of the RGB color components in each area as the input. FIG. 11 shows an example table of hash values of various areas in the RGB raster image of a single page. The hash function can be, for example, MD 5 (Message Digest 5) or SHA (Secure Hash Algorithm). The range of the pixel value is typically R (red)=0-255, G (green)=0-255, and B (Blue)=0-255.

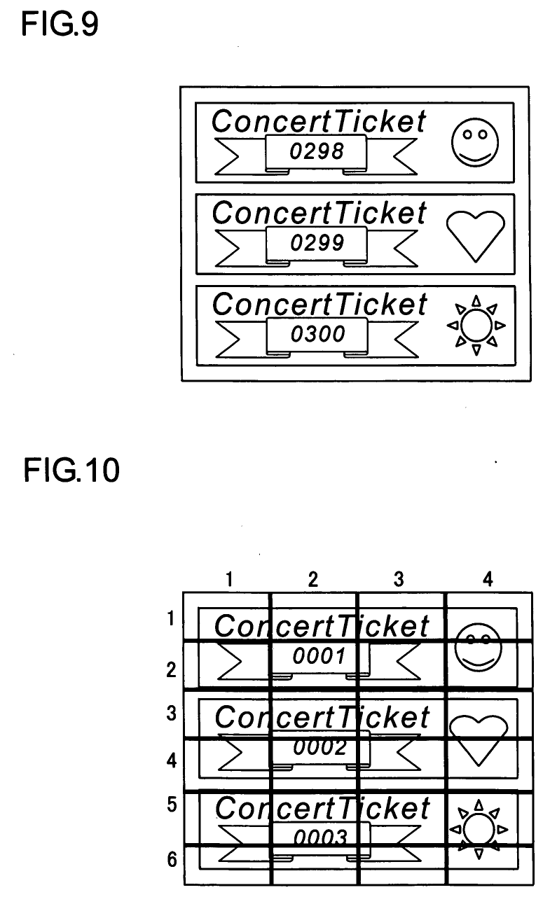

The above processes (S201-S204) are repeated until the processes of all the pages are completed (S205: No). FIG. 9 is an example RGB raster image of the last page with a low resolution.

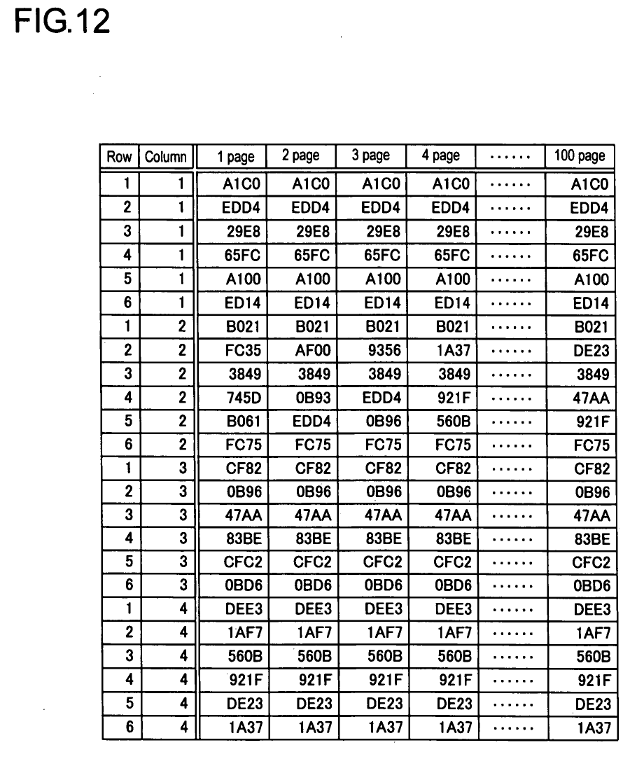

FIG. 12 shows an example table of hash values of various areas in the RGB raster images of all pages. If the number of pages to be processed is large, it is preferable to process them in batches (e.g., batches of 100 pages).

When the entire process for all pages is completed (S205: Yes), the pages are grouped together judging the similarity among the pages using the list of FIG. 12 (S206). The grouping process is performed in the following procedure.

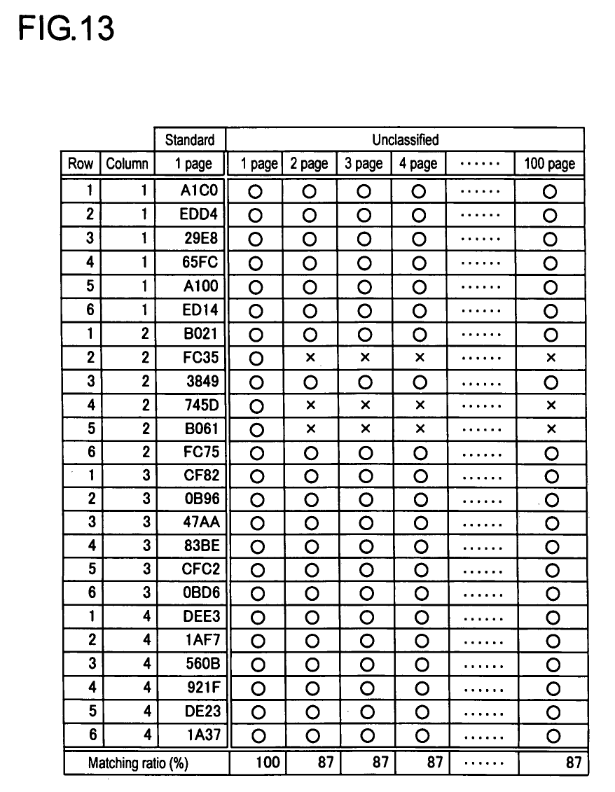

### (1) The smallest page among the pages yet to be classified is determined as the standard page (refer to FIG. 13).

### (2) The values (hash values) of the standard page and other pages are compared by each area and the markings for match (o) and mismatch (x) are recorded (FIG. 13).

### (3) The matching ratio is calculated for each page (FIG. 13). The matching ratio of a page is the ratio of the areas, for which the values match with the values of the corresponding areas of the standard page, relative to the total areas of the page.

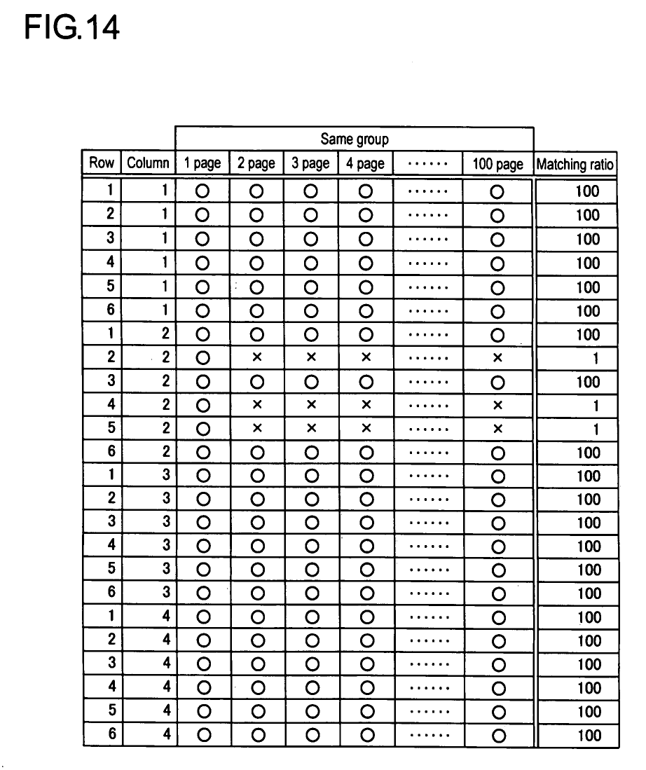

### (4) The page, for which the matching ratio exceeds a certain threshold (e.g., 70%), is considered to belong to the same group as the standard page (refer to FIG. 14). In FIG. 14, it is shown that all pages belong to a single group.

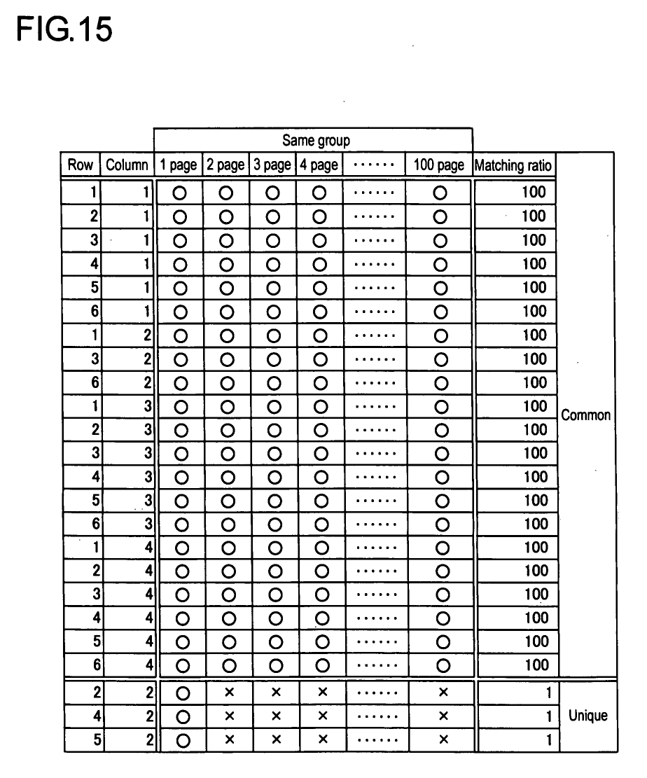

Next, the common areas and the unique areas are extracted for each group (S207). Specifically, the matching ratio is calculated for each area (row 1/column 1, row 2/column 1, . . . row 6/column 4) (refer to FIG. 14). The matching ratio of each area is the ratio of the number of pages, in which the value of a particular area matches with the value of the corresponding area of the standard page, relative to the total number of pages. The areas, of which the matching ratios are 100%, are the common areas and other areas are the unique areas (refer to FIG. 15).

The equally divided areas are compared with each other between pages based on the data obtained by quantification of those areas. Thus, a quick and accurate comparison between the areas is made possible.

Next, a list of page information is prepared (S208).

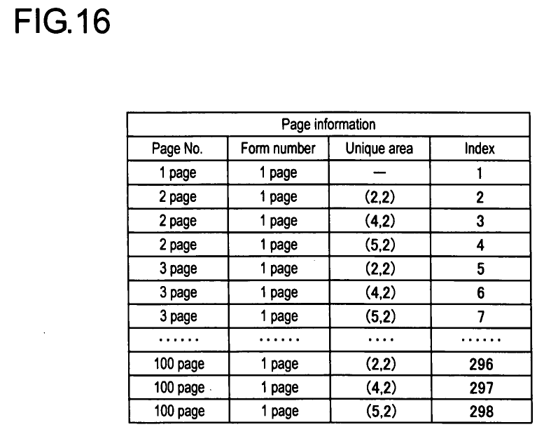

FIG. 16 shows an example of page information. A form number that designates the standard page's number and the information of the unique areas that need to be rasterized individually (location within the page) are stored in relation to the page number in the page information. The information of the unique areas are given in the format of (row number L1, column number L2). The “index” in FIG. 16 is the sequence number. The index is used to identify a raster image to be used in synthesizing as described later.

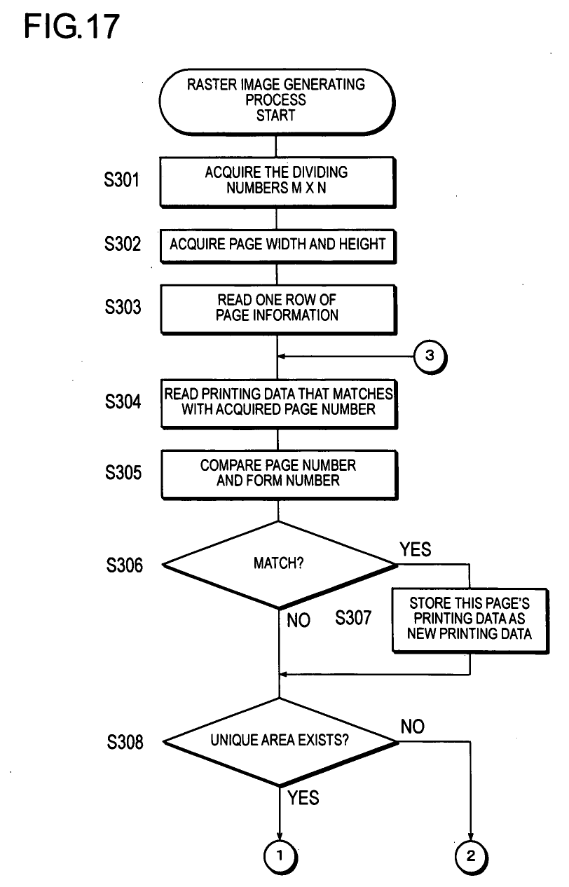

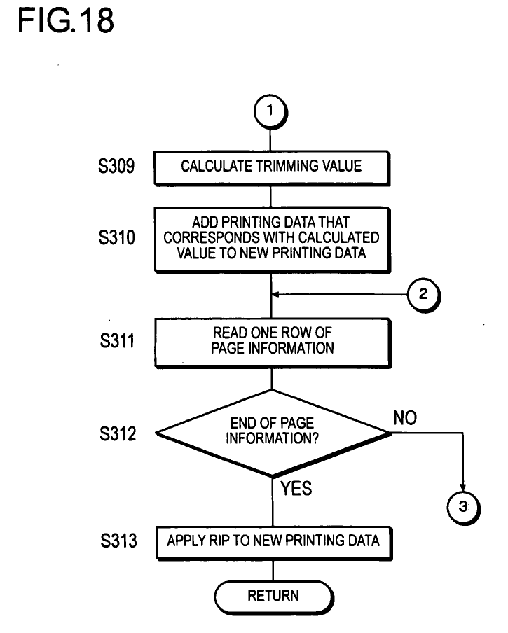

Next, let us describe the raster image generating process with reference to FIG. 17 and FIG. 18.

The raster image generating process shown in FIG. 17 and FIG. 18 is a process for generating CMYK images of a high resolution to be used in printing. As an effective way of generating raster images a thigh-speeds, only a necessary (rectangular) area of all pages is chosen as the target of image generation in this embodiment. For example, application of RIP only to the necessary area can be achieved by reforming the rasterizer to generate the raster image of only the area specified by a starting point of (X, Y), width (W), height (H), and a page number. However, that prevents us from using a universal rasterizer. Therefore, a method of applying RIP only to the necessary area using a trimming control code is adopted in this embodiment.

First, the page division numbers M×N used in the step S203 are acquired (S301). Next, the page width (W) and the height (H) are acquired from the printing data (S302).

Then, one line of the page information (refer to FIG. 16) is read (S303). At this point, the page number, form number, information of the unique area and index (number) are acquired.

The printing data (refer to FIG. 7) of the page whose page number matches with the acquired page number is read here (S304).

Next, the acquired page number is compared with the form number (S305).

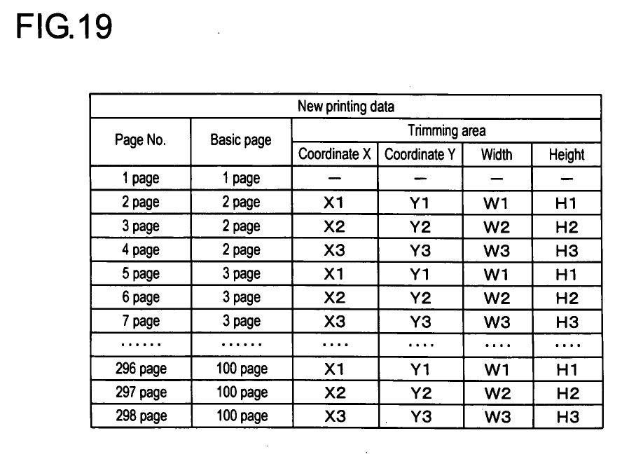

If it is judged that the page number matches with the form number (S306: Yes), the particular page is the page to be used commonly as the form image, so that the printing data of this page is stored as the constituting member of the new printing data (S307, the first record of FIG. 19). The new printing data is stored in the hard disk 24.

In the step S308, a judgment is made as to whether there is the unique area's information exists or not in the loaded page information

If the unique area's information does not exist as shown in the first record of the page information (S308: No), the program advances to the step S311.

In the step S311, the next line of the page information, e.g., the second record is read. At this point, the page number, form number, information of the unique area and index (number) are acquired.

In the step S312, a judgment is made as to whether or not the line read in the step S311 is the end of the page information. If it has reached the end of the page information (S312: Yes), the program advances to the step S313.

For example, if it has not reached the end of the page information as in the case of the second record of the page information being read in the step S311 (S312: No), the program returns to the step S304.

Also, in case the next line of the page information is read, the processes of the aforementioned steps S304-S306 are executed depending on the contents read.

For example, if it is judged that the page number does not match with the form number as shown in the second record of the page information (S306: No), the program advances to the step S308 skipping the step S307.

Also, if it is judged that an unique area exists in the step S308 as in the second record of the page information (S308: Yes), the program advances to the step S309.

The trimming value is calculated in the step S309. The trimming value is used for generating a raster image that corresponds to the unique area in a specific page. Specifically, the area that generates the raster image (trimming area) is calculated using the following formula based on the unique area's information (L1, L2), the division numbers M×N acquired in the step S301, and the width (W) and height (H) of the page acquired in the step S302:

Area's width=W/N

Area's height=H/N

Starting point X=(L1−1)*area width

Starting point Y=(L2−1)*area height

Here, the starting point X and the starting point Y correspond to the coordinates of, e.g., the top left corner point of the area.

Next, the abovementioned calculation result and the printing data (S304, e.g., the second record of FIG. 7) of the corresponding page (e.g., the second page) are added to the new printing data as a pair (S310, e.g., second record of FIG. 9). For example, if the printing data is a PDF file, the control code for trimming is “/CropBox [starting point X, starting point Y, area width, area height].”

For example, since there are a total of three units of information concerning the unique area (second to fourth records of FIG. 16) as to the second page of the page information shown in FIG. 16, the same process is applied to the remaining two unique areas. FIG. 19 shows the new printing data when the printing data processes for all the pages are completed. As shown in FIG. 19, new page numbers are provided in the new printing data to match the indexes of the page information of FIG. 16.

In the step S313, RIP is applied to the new printing data thus prepared. RIP can be executed in the universal rasterizer. This allows the raster image of only the necessary area to be generated very quickly. In other words, the form image that corresponds to the common area used in a plurality of pages and the unique image that correspond to the unique area used only once are generated and are stored in the RAM 23 in relation to the page number of the new printing data. The form image and the unique image are generated as CMYK raster images of the resolution used in printing and applied with the color matching process and the dither process. The color matching process here means a process of reproducing the same color for various different devices that issue or receive color data, and the dither process means an intermediate gradation process that expresses a richer gradation with a predetermined gradation. Typical unique images are, in case of direct mail printing, customer names, customer addresses, etc.

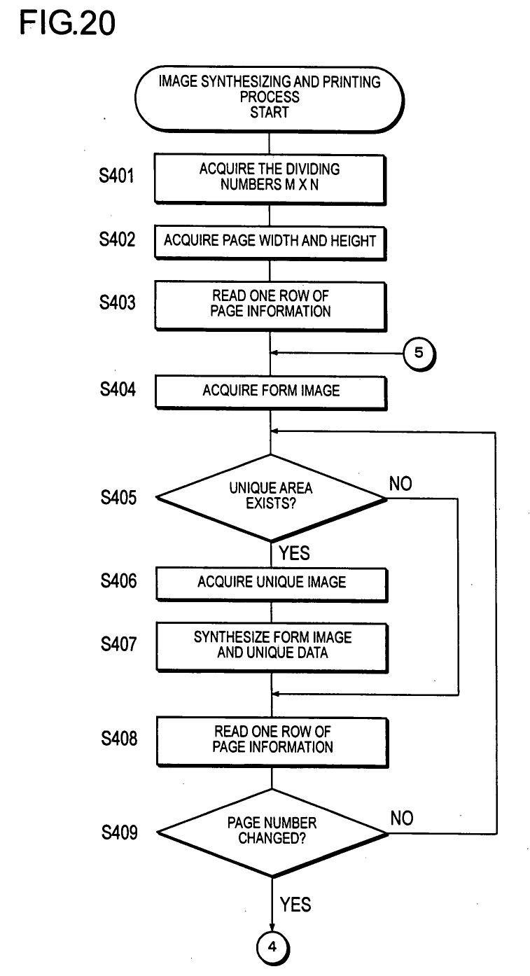

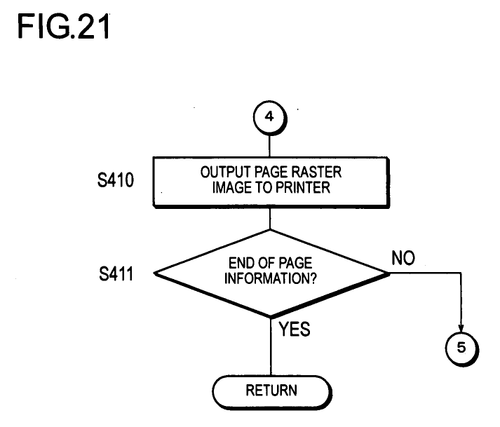

Next, let us describe the image synthesizing and printing process with reference to FIG. 20 and FIG. 21.

First, the numbers M×N of page divisions in vertical and horizontal directions, page width (W) and height (H), which are already used and stored in the RAM 23, are acquired (S401, S402).

Next, one line of the page information (refer to FIG. 16) is read (S403). At this point, the page number, form number, information of the unique area and index (number) are acquired.

Next, the form image of the page, whose page number matches with the form number acquired, is acquired from the RAM 23 (S404).

In the step S405, a judgment is made as to whether there is the unique area's information exists or not in the loaded page information

If the unique area's information does not exist, for example, as shown in the first record of the page information (S405: No), the program advances to the step S408.

In the step S408, the next line of the page information, e.g., the second record is read. At this point, the page number, form number, information of the unique area and index (number) are acquired.

In the step S409, a judgment is made as to whether or not the page number of the line read in the step S408 has made any difference compared to the page number of the line read in immediately prior to it.

If the page number has changed, for example, as in the case of the second record of the page information being read in the step S408 (S409: Yes), the program returns to the step S410.

In the step S410, the page raster image is outputted to the printer 4A. The page raster image is generated by synthesizing the unique image with the form image as needed (refer to the steps S405-S407 to be described later).

In the step S411, a judgment is made as to whether or not the line (row) read in the step S408 is the end of the page information. If it has reached the end of the page information (S411: Yes), the program returns to the flowchart of FIG. 5.

If it has not reached the end of the page information, for example, as in the case of the second record of the page information being read in the step S408 (S411: No), the program returns to the step S404.

In the step S404, the form image of the page, whose page number matches with the form number acquired as described before, is acquired from the RAM 23.

Also, if it is judged that an unique area exists in the step S405, for example, as in the second record of the page information (S405: Yes), the program advances to the step S406.

In the step S406, the unique image of the page number that matches with the acquired index is acquired from the RAM 23 (S406).

In the step S407, the unique image acquired in the step S406 is synthesized with the form image acquired in the step S404.

The area in which the unique image is synthesized with the form image is calculated using the following formula based on the unique area's information (L1, L2), the division numbers M×N acquired in the step S401, and the width (W) and height (H) of the page acquired in the step S402:

Area's width=W/N

Area's height=H/N

Starting point X=(L1−1)*area width

Starting point Y=(L2−1)*area height

Here, the starting point X and the starting point Y correspond to the coordinates of, e.g., the top left corner point of the area.

After the unique image that corresponds to the second record of the page information, for example, the next line of the page information is read (S408, the third record of FIG. 16). In this case, since the page number has not been changed (S409: No), a judgment is made again as to whether the unique area's information exists or not in the page information which is read (S405). Since there are three unique areas in case of the second page (second record to fourth record of FIG. 16), the unique images that correspond to the two remaining unique areas are similarly acquired and further synthesized (S406, S407).

As can be seen from the above, the printer controller 2A of the present embodiment divides the image data within each page, compare the divided areas of various pages to identify separately the common areas that can be used in a plurality of pages from the unique areas that do not belong to said common areas, applies RIP to the unique areas and the common areas for one of the plurality of pages containing the common areas, synthesizes the common areas and the unique areas to which RIP was applied, and outputs the synthesized image data to the printer 4A.

In this embodiment, as can be seen from the above, image data is equally divided within a page, the equally divided areas are compared to identify the common areas separately from the unique areas, and the image data of only the necessary areas among the entire image data is chosen as the target of the image process for printing such as RIP. Therefore, it is possible to shorten the time for image process for printing such as RIP to be applied to the image data without asking the file format of the received printing data and without any complication of the procedure. This improves the productivity of the printing process.

Next, the second embodiment will be described below focusing primarily on the points different from the first embodiment.

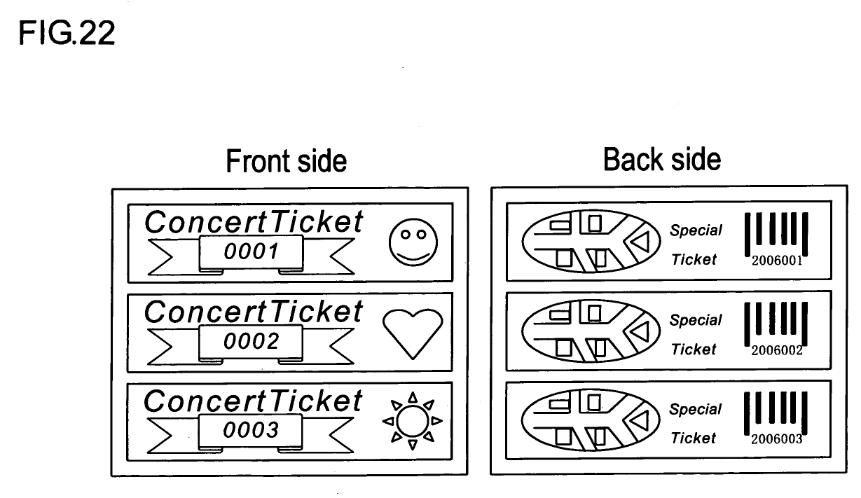

In the first embodiment, there was only one form image that is used common to all the pages. On the contrary, in the second embodiment, a case where a plurality of types of form images exists will be described. For example, a case where the printing data having front pages and back pages is printed on both sides of the printing medium will be discussed. FIG. 22 is a drawing to show an example RGB raster image generated with a low resolution in the second embodiment, which corresponds to FIG. 8 and FIG. 9 of the first embodiment.

The process executed in the second embodiment is identical to the process executed in the first embodiment (refer to the flowcharts of FIGS. 5, 6, 17, 18, 20 and 21). In other words, the contents of the printing data to be applied in the second embodiment are different from those of the first embodiment as shown above.

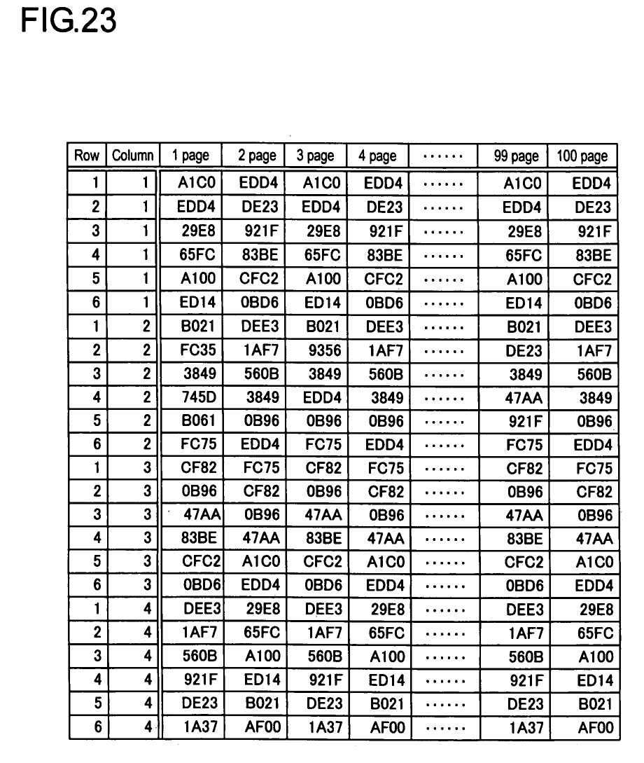

FIG. 23 shows an example table of hash values of various areas in the RGB raster images of all pages in the second embodiment.

The similarity for each page is judged based on the list of FIG. 23 so that each page is grouped (S206 of FIG. 6). The grouping process is performed in the following procedure.

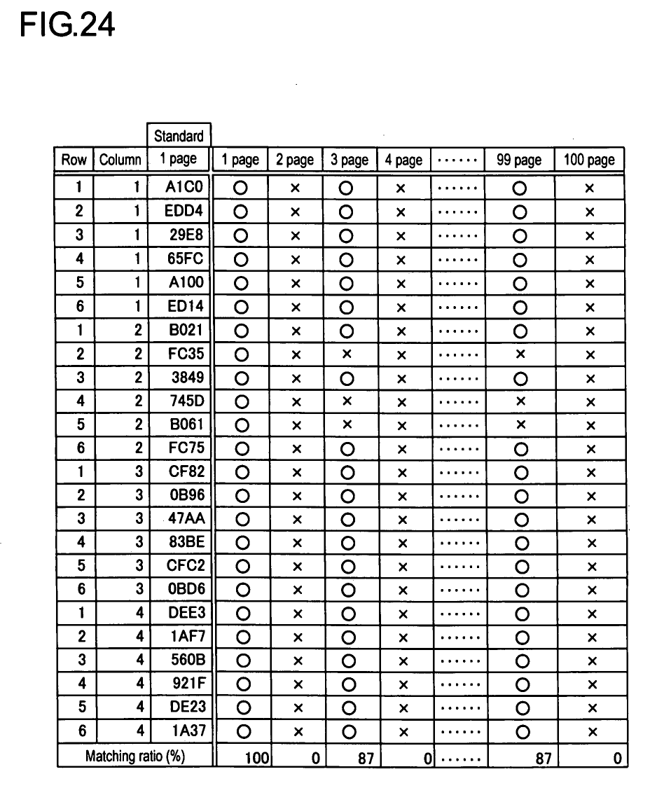

### (1) The smallest page among the pages yet to be classified is determined as the standard page (refer to FIG. 24).

### (2) The values (hash values) of the standard page and other pages are compared by each area and the markings for match (o) and mismatch (x) are recorded (FIG. 24).

### (3) The matching rate is calculated for each page (FIG. 24).

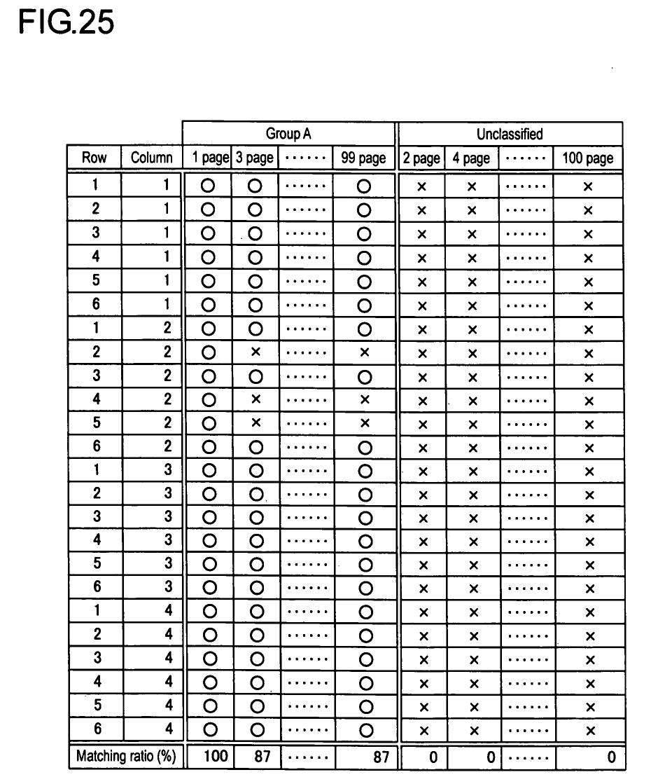

### (4) The page, for which the matching rate exceeds a certain threshold (e.g., 70%), is considered to belong to the same group as the standard page (refer to FIG. 25).

### (5) If the matching ratio per page is less a specified threshold value, it is construed that the page is not yet classified (FIG. 25).

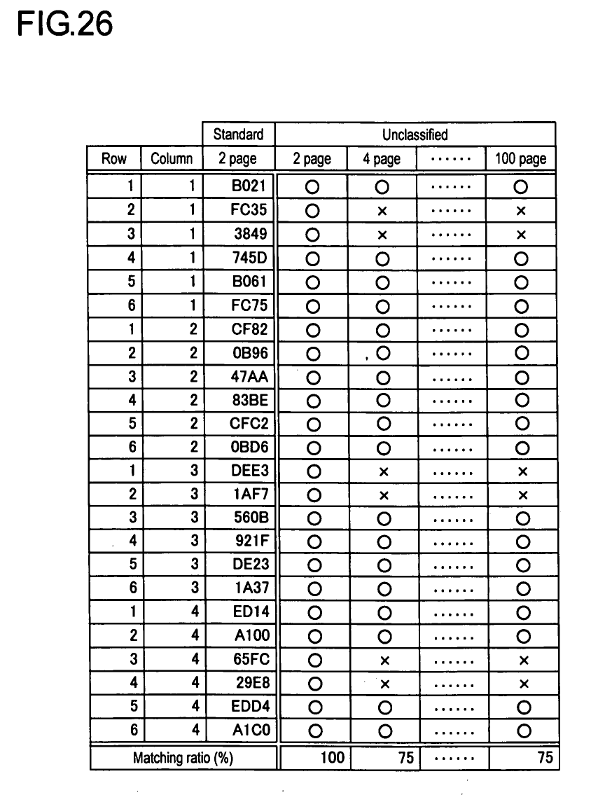

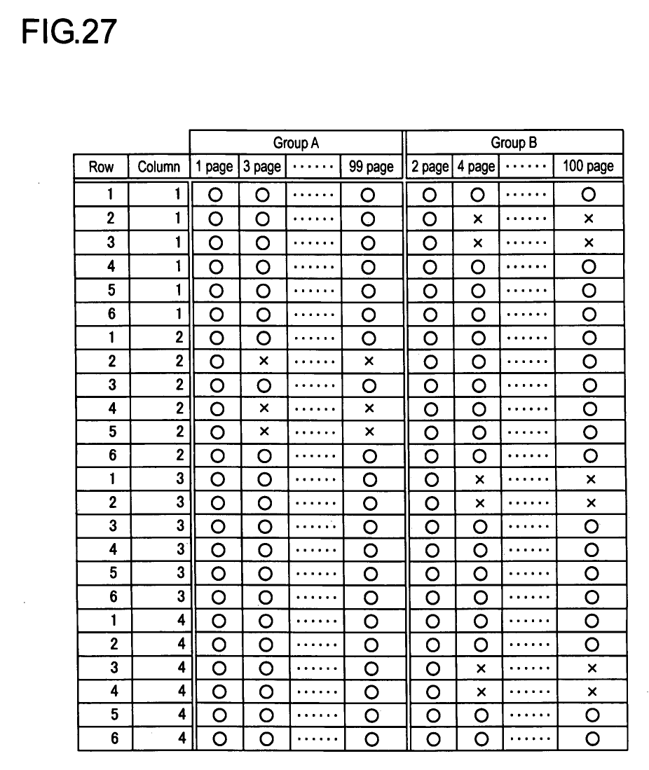

### (6) The grouping process is repeated by returning to the step (1) above (FIG. 26). The grouping process is completed by the above procedure (FIG. 27).

Next, the common areas and the unique areas are extracted by groups (S207 of FIG. 6) to prepare the list of page information (S208 of FIG. 6).

As can be seen from the above, the common areas of a plurality of kinds are identified in the second embodiment. Thus, the present invention is applicable to a case in which a plurality of form images exists as in a case of printing the data having the front page and the back page on both sides of a printing medium.

Next, the third embodiment will be described below focusing primarily on the points different from the first and second embodiments.

In the first and second embodiments, it is identified that areas with the matching ratio of 100% per each area are the common areas, and others are the unique areas. However, it often happens in a case, for example, of variable data printing, that the same image occurs multiple times although noncyclically.

In the third embodiment, an area that is not a common area but is used on a plurality of pages is defined as a reusable area and a method of reusing the raster image of such an area will be provided.

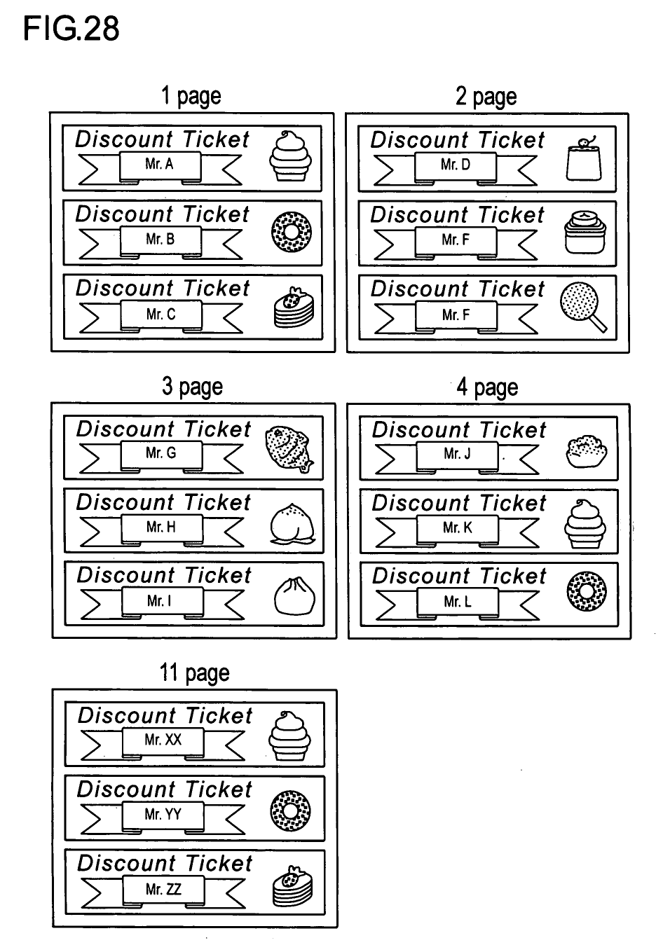

FIG. 28 is a drawing to show an example RGB raster image generated with a low resolution in the third embodiment, which corresponds to FIG. 8 and FIG. 9 of the first embodiment.

FIG. 28 is an example of merchandise discount tickets that meet the clients' tastes. There are 10 merchandises. In this example, a cycle of ten merchandises ranging from an ice cream cone (top row of page 1) to a cream puff (top row of page 4) is repeated. Although the order of appearance of each merchandise occur at random if we are to match the preference of individual clients, we will describe the case of discount tickets as shown in FIG. 28 in order to simplify the explanation.

In case of FIG. 28, by caching the raster image (unique image) of the ice cream cone on the top row of the first page, said image can be reused when it appears on the top row of the 11th page, the top row of the 21st page, and so on. However, it cannot be reused when the raster image of the ice cream cone appears on the middle or bottom row of a page as the hash value would be different. The problem can be handled no matter how often the ice cream cone appears in the printing data by cashing the raster image of the ice cream cone as it appears on the middle row of the fourth page and the bottom row of the seventh page. The number of raster images to be cached for all the ten merchandises is the number of merchandises x the number of merchandises within one page in this case=30. If it is printing data consisting of 100 pages and the merchandises appear in a fixed order every time, it needs only to generate the raster images for the first 10 pages and only to take care of the processes for the unique areas (areas where the customer names exist) for the remaining 90 pages. Since the cache hit ratio drops when the number of merchandises increase, so that it is necessary to judge whether to allow reuses or not by setting up a threshold value. The following is an example of reuse sequence procedure:

### (1) Execute the steps S201-S206 of FIG. 6.

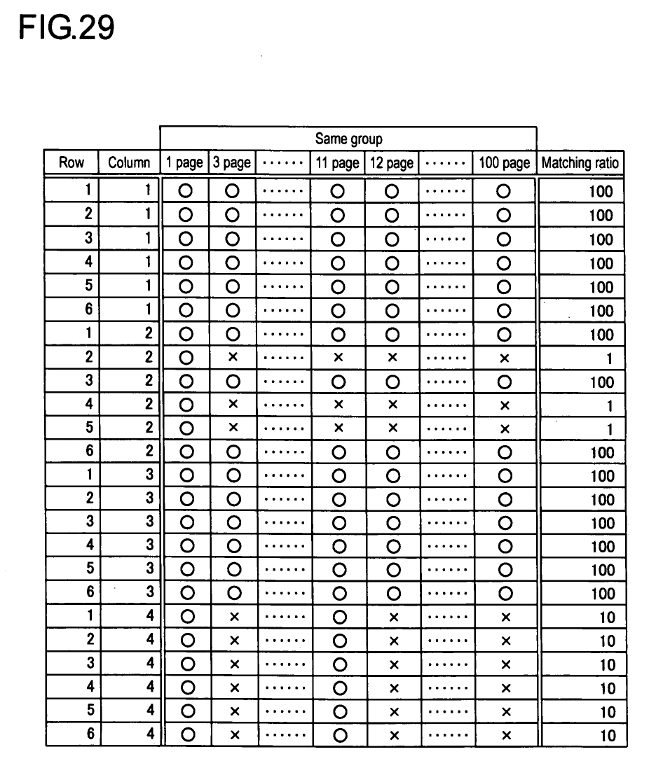

### (2) The common areas and the unique areas are extracted for each group (refer to FIG. 29). In case of FIG. 28, the unique areas are areas [(2,2), (4, 2), (5, 2)] where the customer names appear with the matching ratio per area of 1%.

(3) The area with a matching ratio per area exceeding a threshold (e.g., 10%) is identified as a reusable area. Using the first page of FIG. 28 as an example, the reusable areas are areas where the ice cream cone exists [(1, 4), (2, 4)], areas where the doughnut exists [(3, 4), (4, 4)], and where the short cake exists [(5, 4), (6, 4)].

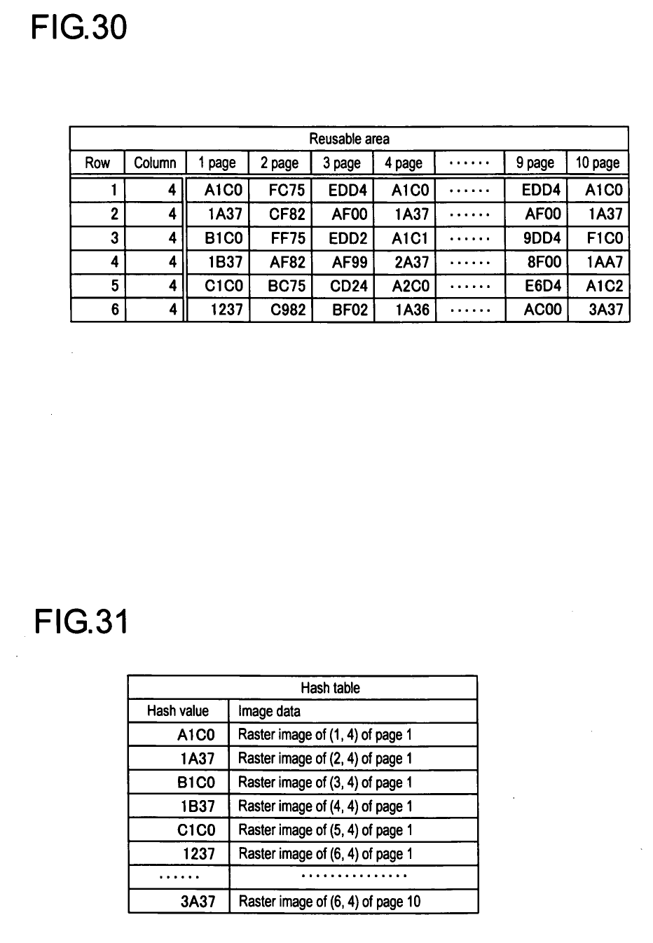

### (4) The list showing the hash values of the reusable area of the above step (3) is prepared (FIG. 30).

(5) The raster image generating unit 25 applies RIP to the reusable areas and generates CMYK raster images of the resolution to be use in printing. Using the hash values in the list of FIG. 30 as the keys, the raster images of the generated reusable areas are cached in the RAM 23.

### (6) The image synthesizing unit 27 acquires the corresponding raster image to execute the image synthesizing process based on the hash table stored in the RAM 23 (FIG. 31).

The third embodiment, as can be seen from the above, identifies reusable areas, which are other than the common areas and which are used in a plurality of pages which is less than the number of pages where the common area is used, applies RIP to the reusable areas for one of the plurality of pages that have the reusable areas, and synthesizes the common areas, the reusable areas and the unique areas to which RIP was applied.

Thus, the third embodiment can shorten the time required for image process for printing such as RIP applied to the image data, and further improve the productivity of the printing process as a result.

Next, the fourth embodiment will be described below focusing primarily on the points different from the first, second, and third embodiments.

Although the description in the above embodiments pertained to a case where the received printing data is PDL data, the present invention is applicable to a case where the printing data is page image data to which RIP has been applied. The page image data to which RIP has been applied includes multi-page TIFF images, images generated by GDI driver, bitmap images, and JPEG images.

The process executed in the fourth embodiment is identical to the processes executed in the embodiments described above except that the step S202 of FIG. 6 is unnecessary.

Thus, the fourth embodiment is cable of shortening the time required for image processes for printing such as the color mapping process, dither process, etc. by applying the present invention even in case of page image data in which the printing data has been applied with RIP. This improves the productivity of the printing process.

The invention is not limited to the embodiment described above, but also can be changed in various ways within the scope of the claims.

Although the invention was described in the above embodiments for a case where the printer controller as the image processing apparatus and the printer as the printing apparatus are installed independently, the printer controller can be installed in the printer.

Also, although the embodiments described above uses a printer as the printing apparatus, the invention is not limited to it. The present invention is applicable to an image forming apparatus such as MFP (Multi-Function Peripheral) and a copying machine as well.

The means and method of conducting various processes in the printing system according to the present invention can be realized by means of a dedicated hardware circuit, or a programmed computer. Said program can be provided either by a computer readable recording medium such as a flexible disk and a CD-ROM, or by being supplied on-line via a network such as the Internet. In this case, the program recorded on the computer readable recording medium is normally transferred to and stored in a storage unit such as a hard disk. Said program can also be provided as independent application software or can be built into the software of the image processing apparatus as a part of its function.

What is claimed is:

1. An image processing apparatus, comprising:
an image analyzing unit for dividing image data into a plurality of areas of equal sizes within a page, comparing the equally divided areas between pages, and identifying a common area that can be used in a plurality of pages and a unique area that does not belong to said common area;
an image processing unit for applying an image process for printing to said unique area and said common area for one of the plurality of pages containing said common area;
an image synthesizing unit for synthesizing said common area and said unique area to which said image process has been applied; and
an output unit for outputting the synthesized image data to a printing unit.

2. The image processing apparatus as claimed in claim 1, wherein
said image data is divided into an equally spaced lattice shape within a page.

3. The image processing apparatus as claimed in claim 1, wherein
the equally divided areas are compared with each other between pages based on the data obtained by quantification of those areas.

4. The image processing apparatus as claimed in claim 1, wherein
said image analyzing unit identifies a plurality of common area types.

5. The image processing apparatus as claimed in claim 1, wherein
said image analyzing unit identifies reusable area that is other than said common area and is used in a plurality of pages the number of which is less than that of the pages that contain said common area;
said image processing unit applies an image process for printing to said reusable area for one of the plurality of pages that contain said reusable area; and
said image synthesizing unit synthesizes said common area, said reusable area, and said unique area to all of which said image process has been applied.

6. The image processing apparatus as claimed in claim 1, wherein
said image processing unit converts PDL data inputted into said image processing apparatus into bitmap-formatted image data of a low resolution, lower than that of bitmap-formatted image data used in printing.
said image analyzing unit divides bitmap-formatted image data of a low resolution into a plurality of areas of equal sizes within a page, comparing the equally divided areas between pages, and identifying a common area that can be used in a plurality of pages and a unique area that does not belong to said common area; and
said image processing unit applies an image process to said unique area and said common area for one of the plurality of pages containing said common area in said PDL data for converting them into bitmap-formatted image data used in printing.

7. The image processing apparatus as claimed in claim 1, wherein
said image process is a color matching process.

8. The image processing apparatus as claimed in claim 1, wherein
said image process is a dither processing.

9. An image processing method, comprising:
dividing image data into a plurality of areas of equal sizes within a page, comparing the equally divided areas between pages, and identifying a common area that can be used in a plurality of pages and a unique area that does not belong to said common area;
applying an image process for printing to said unique area and said common area for one of the plurality of pages containing said common area;
synthesizing said common area and said unique area to which said image process has been applied; and
outputting the synthesized image data to a printing unit.

10. A computer readable recording medium stored with an image processing program causing a computer to execute a process comprising:
dividing image data into a plurality of areas of equal sizes within a page, comparing the equally divided areas between pages, and identifying a common area that can be used in a plurality of pages and a unique area that does not belong to said common area;
applying an image process for printing to said unique area and said common area for one of the plurality of pages containing said common area;
synthesizing said common area and said unique area to which said image process has been applied; and
outputting the synthesized image data to a printing unit.

11. An image processing apparatus, comprising:
an image analyzing unit for dividing image data into a plurality of areas of equal sizes within a page, comparing the equally divided areas between areas, and identifying a common area that can be used in a plurality of areas and unique area that does not belong to said common area;
an image processing unit for applying an image process for printing to said unique area and said common area as one area common to the plurality of areas and;
an image synthesizing unit for synthesizing said common area and said unique area to which said image process has been applied; and
an output unit for outputting the synthesized image data to a printing unit.
